(19) United States
(12) Patent Application Publication
(10) Pub. No.: US 2022/0258520 A1
(43) Pub. Date: Aug. 18, 2022

(54) High-Gloss Silver Watermark

(71) Applicant: JT International S.A., Geneva (CH)

(72) Inventor: Servet Tuncer, Konz-Könen (DE)

(73) Assignee: JT International S.A., Geneva (CH)

(21) Appl. No.: 17/617,133

(22) PCT Filed: Jul. 14, 2020
(86) PCT No.: PCT/EP2020/069858

§ 371 Date: Dec. 7, 2021

(30) Foreign Application Priority Data
Jul. 15, 2019 (EP) 19186211.9

(51) Int. Cl. B42D 25/333; D21H 21/48; D21H 27/10; D21H 19/38; D21H 19/82; B42D 25/373; B41M 3/14

(52) U.S. Cl. CPC B42D 25/333; D21H 21/48; D21H 27/10; B41M 3/14; D21H 19/828; B42D 25/373; D21H 19/38

(57) ABSTRACT

A layer-structure includes at least a base layer with a top surface and a top layer, wherein the top layer is arranged above the base layer in a height direction, wherein a first color section is partially provided in and/or on the top surface of the base layer, the first color section and the top surface of the base layer having a luminance contrast, wherein the luminance contrast, defined as Weber contrast, has a value that is at least 0.20, and wherein the first color section and the top surface of the base layer are covered by the top layer, so that a watermark visual appearance is provided.

### CROSS-REFERENCE TO RELATED APPLICATIONS

The present application is a national phase entry under 35 U.S.C. § 371 of International Application No. PCT/EP2020/069858, filed Jul. 14, 2020, published in English, which claims priority to European Application No. 19186211.9 filed Jul. 15, 2019, the disclosures of which are incorporated herein by reference.

### BACKGROUND OF THE INVENTION

The present invention relates to a layer-structure for providing a high-gloss silver watermark visual appearance and/or embossing/debossing visual appearance and a method to prepare such a layer-structure, according to the preamble of present claims 1 and 14.

A conventional watermark is usually caused by thickness or density variations in a paper material providing images or patterns in said paper when viewed by transmitted light. On the other hand, embossings and debossings by means of either raised or recessed three-dimensional images and/or patterns in a paper material are created by altering the surface of said paper material commonly using two dies that fit into each other. Such watermarks, embossings and debossings are applied to paper materials as a design element and a decorating effect or for safety reasons, for example to complicate counterfeiting of banknotes. Usually, the creation of a watermark, an embossing or a debossing requires a separate creation step within the production process of the paper material itself or a product made of said paper material and additional specialized tools like dies or the like. Thus, the creation of a watermark, an embossing or a debossing is time-consuming and expensive.

DE 101 24 221 A1 shows a document comprising such a security element. The effect achieved therein is designed to impede counterfeiting, i.e. to make it impossible to achieve the same visual effect by one layer of print or by photocopying. To achieve this, this document suggests certain color combinations of a first print and a second print.

### BRIEF SUMMARY OF THE INVENTION

It is therefore the objective of the present invention to provide a watermark and/or embossing/debossing effect by a layer-structure avoiding specialized tools and prolonged additional steps.

The afore-mentioned drawbacks are eliminated by the object of claim 1. Preferred embodiments of the invention are object of the subclaims.

A layer-structure according to the present invention comprises at least a base layer with a top surface and a top layer, wherein the top layer is arranged above the base layer in a height direction, wherein a first color section is partially provided in and/or on the top surface of the base layer, the first color section and the top surface of the base layer having a luminance contrast, wherein the luminance contrast, defined as Weber contrast, has a value that is at least 0.20, and wherein the first color section and the top surface of the base layer are covered by the top layer, so that a watermark visual appearance is provided.

A watermark visual appearance shall be equivalent to a watermark effect. In the light of the present invention, a watermark visual appearance or watermark effect resembles a watermark created by known techniques like partly varying the thickness or density of the layers, altering the structure of one or more layers. The visual appearance or effect according to the invention is achieved without the need of altering the structure of one or more layers, but provides a similar look. This is achieved by the luminance contrast of the base layer and the first color section, wherein the luminance contrast of the base layer and the first color section is discernible although the top layer is covering the base layer and the top layer. The watermark effect may preferably also include an embossing/debossing effect, in other words an embossing/debossing visual appearance. This preferably visually resembles the outcome of an embossing/debossing process with dies.

This means that the watermark visual appearance and eventual embossing/debossing visual appearance are achieved by the luminance contrast of the base layer, in particular its surface, and the first color section. In particular, this specific effect is not achieved by a certain color combination between the first color section and the top layer, as DE 101 24 221 A1 might suggest.

A contrast according to the present invention is the difference in luminance between adjacent objects determined by a difference in color and brightness. There is a plurality of different common definitions of contrast. In the following, the Weber contrast C_{W} defined as

$${C}_{W} = \frac{( {L}_{max} - {L}_{min} )}{{L}_{min}}$$

or the simple luminance contrast Cₛᵢₘₚₗₑ defined as

$${C}_{s i m p l e} = \frac{{L}_{max}}{{L}_{min}}$$

are used, wherein Lₘₐₓ is the luminance of the object with the higher luminance and Lₘᵢₙ is the luminance of the object with the lower luminance. The contrasts indicated above and those mentioned in the following each relate to the Weber contrast, unless explicitly specified otherwise. The SI unit for luminance is candela per square metre (cd/m²).

The layer-structure of the present invention preferably provides a height direction, a width direction that is perpendicular to the height direction, and a length direction that is perpendicular to the height direction and the width direction. Preferably, the base layer extends in a plane defined by the width direction and the length direction.

Preferably, a characteristic of the watermark visual appearance depends on the luminance contrast of the base layer and the first color section. Preferably, the embossing/debossing effect also depends on the luminance contrast of the base layer and the first color section The appearance of the effects varies with the luminance contrast, meaning that the higher the contrast the stronger is the visual appearance and vice versa.

In view of the present invention, it is possible that the first color section can be provided as a continuous section/single element or divided into at least two parts (not connected), depending on the desired watermark visual appearance and/or embossing/debossing visual appearance is provided.

The object of the present invention is also solved by a packaging material comprising a layer-structure, which comprises at least a base layer with a top surface and a top layer, wherein the top layer is arranged above the base layer in a height direction, a first color section is partially provided in and/or on the top surface of the base layer, the first color section and the top surface of the base layer having a luminance contrast, wherein the luminance contrast, defined as Weber contrast, has a value that is at least 0.20, and wherein the first color section and the top surface of the base layer are covered by the top layer, so that a watermark visual appearance is provided.

Preferably, a packaging is formed by folding of a blank of the packaging material. More preferably, the packaging material comprises the watermark visual appearance. Preferably, the packaging material also comprises an embossing/debossing visual appearance. Such decorative finishing techniques sets clearly the pack-aging apart from conventional packaging. Preferably, the usual thickness of packaging material is in the range of 60 g/m² to 210 g/m², more preferably, 200 g/m² to 1000 g/m², most preferably 900 g/m² to 3000 g/m².

In a preferred embodiment, the value of the luminance contrast, defined as Weber contrast, is at least 0.25, preferably at least 0.30, more preferably at least 0.35 and particularly preferably at least 0.38. By these values, the visual appearance of the effects is ensured and easily discernible.

It shall be understood that the luminance contrast of the base layer corresponds to the luminance contrast of the top surface of the base layer. It is possible that the base layer is made of a uniform material with a uniform color or that the base layer has a surface coating by means of a top surface, made of a different material or having a different color.

In a preferred embodiment, the top layer consists of a metallic gloss ink composition, in particular a silver gloss ink composition, said metallic gloss ink composition comprising metallic particles. Preferably, the metallic particles can have different particle sizes. The watermark visual appearance and/or embossing/debossing visual appearance is preferably obtained by metallic gloss ink compositions. Said metallic gloss ink compositions are well known in the art, having different ingredients and proportions of ingredients and it should be understood that these kinds of ink composition are in general preferably suitable for the application as a top layer. It is also possible that the metallic gloss ink composition is a UV metallic gloss ink composition. Said UV ink composition can be cured/dried by UV light.

In a preferred embodiment, the metallic gloss ink composition is printed on the top surface of the base layer and the first color section. By using a printing method, the top layer can be easily applied on the base layer and/or the first color section. In the light of the invention, different suitable printing techniques can be used, for example letterpress printing, gravure printing, flexography printing, dye-sublimation printing, inkjet printing, laser printing, offset printing, thermal printing, screen printing or pad printing and any combinations thereof. The possible printing techniques shall not be limited to these examples.

In a preferred embodiment, the first color section is provided as line textures and/or solid design elements. The form or shape of the first color section can vary, depending on the application and the desired watermark visual appearance and/or embossing/debossing visual appearance. Preferably, every design and form of the first color section can possibly be applied.

In a preferred embodiment, the first color section consists of an ink composition, said ink composition being printed on the top surface of the base layer. Applying the first color section as an ink composition and by a printing method, the application of the first color section is facilitated. A plurality of ink compositions is well-known in the art and it should be understood that all ink compositions that are suitable for a printing application can be used in conjunction with the first color section of the present invention. Moreover, different printing techniques can be used, for example letterpress printing, gravure printing, flexography printing, dye-sublimation printing, inkjet printing, laser printing, offset printing, thermal printing, intaglio printing, screen printing, pad printing or relief printing and any combinations thereof. The possible printing techniques shall not be limited to these examples. It is further possible that the first color section/ink composition remains adhered on the top surface of the base layer and/or that the first color section/ink composition at least partially diffuses into the base layer.

In a preferred embodiment, the first color section has a color with a tone value range between 50% and 100%, preferably between 60% and 100%, more preferably between 70% and 100% and particularly preferably between 80% and 100%. The tone value range corresponds to a darkness and/or a lightness of the first color section and/or the ink composition that is used for the first color section, respectively. This means that a high tone value range is equal to a darker color and a low tone value range is equal to a lighter color. In the light of the present invention, a first color section with a substantially high tone value range is preferred since darker colors provide a more significant luminance contrast with regard to the base layer and the first color section.

In a preferred embodiment, a bottom surface of the top layer is in contact with the first color section and the top surface of the base layer. This guarantees that the top layer is covering the first color section and the base layer. Furthermore, the adhesion of the top layer on the first color section and the top surface of the base layer is ensured.

In a preferred embodiment, a primer layer is arranged between the base layer and the top layer in a height direction of the layer-structure. Primers are well-known in the art. A primer can yield different advantageous properties, like an even planar surface to enhance adhesion and, in the case of a metallic gloss ink composition, the brilliance/shining of the color, since the contained metallic particles can be more beneficially arranged on an even surface. It is also possible that different primers are applied, exhibiting different beneficial properties necessary for the corresponding application. The primer layer preferably extends in parallel to the base layer and the top layer in the width direction and the length direction of the layer structure. The primer layer can also consist of a UV primer that is curable/dryable by UV light.

In a preferred embodiment, the primer layer is in contact with the top surface of the base layer, the first color section and the bottom surface of the top layer, covering the top surface of the base layer and the first color section. This arrangement of the primer layer ensures that the base layer and the first color section are covered by the primer layer and that the top layer is only in contact with the primer layer but not with the base layer and the first color section. Hence, an even planar surface can be achieved by the primer layer on which the top layer is applied, regardless of the properties of the base layer and the first color section.

In a preferred embodiment, the base layer is made of a carton, paper, cardboard, paperboard, metal, wood, glass and/or plastic material. The material of the base layer can be varied and thus, the watermark visual appearance and/or embossing/debossing visual appearance can be obtained on different surfaces.

In a preferred embodiment, the top layer is continuous and/or has a uniform thickness throughout. The top layer preferably has no intended interruptions or gaps. Thereby, the top layer is easily applicable onto the base layer and onto the first color section without the need of special techniques, for example by known printing techniques. Preferably, the top layer extends in parallel to the base layer.

Further preferably, the top layer is fully covering by means of being opaque. Therefore, the top layer provides no intended transparency and/or is transparent. Particularly preferably, the top layer has a continuous and uniform thickness throughout. The top layer is preferably planar/even without any concave and/or convex parts or the like.

In a preferred embodiment, at least a second color section is provided in and/or on the top surface of the base layer. Thereby, different designs and appearances could be realized. Preferably, the at least second color section is provided temporally and/or spatially displaced or at the same time and place (same printing step) with regard to the application of the first color section.

In a preferred embodiment, the at least second color section consists of the same ink composition or consists of a different ink composition as the first color section, having a different color and/or different components. Preferably, the at least second color section or the different ink composition, respectively, and the base layer have a different luminance contrast than the first color section and the base layer. By applying at least the second color section with a different luminance contrast, the watermark visual appearance and/or embossing/debossing visual appearance can be varied and thus, the first color section and the at least second color section exhibit a different watermark visual appearance and/or embossing/debossing visual appearance by means of the discernibility of the effect.

The object of the present invention is also solved by a method for preparing a layer-structure, the method comprising the following steps:
a) providing a base layer with a top surface;
b) providing a first color section in and/or on parts of the top surface of the base layer;
c) providing a top layer above the base layer in a height direction of the layer-structure, covering the first color section and the top surface of the base layer;
wherein the first color section and the top surface of the base layer have a luminance contrast,
wherein the luminance contrast, defined as Weber contrast, has a value that is at least 0.20.

In a preferred embodiment, the method comprises the additional step:
d) providing a primer layer between the base layer and the top layer;
wherein the step d) is conducted after step b).

The primer layer can yield beneficial properties like an even surface for improving the adherence of the top layer.

For all preferred embodiments of the method as described herein, it is possible that one or more of the features as described with respect to the layer-structure are used. For all preferred embodiments of the layer-structure as described herein, it is possible that one or more of the features as described with respect to the method are used. Therefore, features described in relation to the layer-structure shall apply mutatis mutandis to the method and vice versa.

### BRIEF DESCRIPTION OF THE DRAWINGS

Further advantages, objectives and features of the present invention will be described, by way of example only, in the following description with reference to the appended figures and examples. In the figures, like components in different embodiments can exhibit the same reference symbols.

The figures show:

FIG. 1a a sectional view of a preferred embodiment of the layer-structure according to the present invention;

FIG. 1b a sectional view of another preferred embodiment of the layer-structure according to the present invention;

FIG. 2a a test base layer with a first color section according to a preferred embodiment of the invention;

FIG. 2b the test base layer with the first color section according to FIG. 2a covered by a top layer;

FIG. 3a a test base layer with a first color section (left) and the test base layer covered by a top layer (right) according to a preferred embodiment of the invention;

FIG. 3b a test base layer with a first color section covered by a top layer according to a

### DETAILED DESCRIPTION

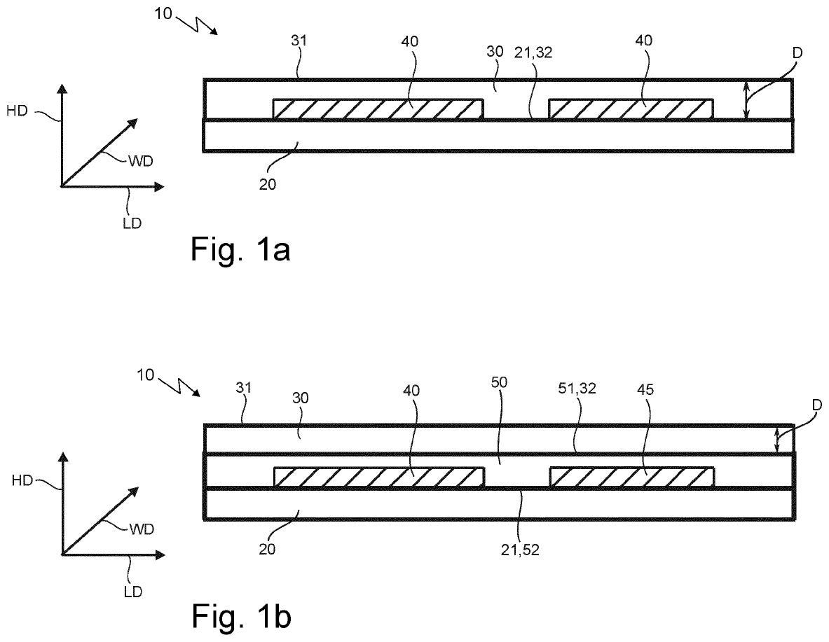

In FIG. 1a, a layer-structure 10 according to a preferred embodiment of the invention is shown. The layer-structure 10 comprises a base layer 20, a top layer 30 and a first color section 40. The base layer 20 has a top surface 21. Moreover, the base layer 20 extends substantially in a width direction WD and in a length direction LD.

The first color section 40 is arranged on the top surface 21 of the base layer 20. In this embodiment of the present invention, the first color section 40 is provided as two separate parts, but it is also conceivable that the first color section 40 is continuous. Moreover, the first color section 40 could be provided in the form of more separate/individual parts. It is also possible that the first color section 40 is provided in and/or on the top surface 21 of the base layer 20.

The top layer 30 has a top surface 31 and a bottom surface 32 and is arranged on the base layer 20 with regard to a height direction HD. The bottom surface 32 of the top layer 30 is in contact with the top surface 21 of the base layer 20 and the first color section 40. Thereby, the top layer 30 covers the top surface 21 of the base layer 20 and the first color section 40. The base layer 20 and the top layer 30 extend in parallel. The top surface 31 and the bottom surface 32 of the top layer 30 extend in parallel. A thickness D of the top layer 30 is continuous and constant across the layer-structure 10. It is possible that the thickness D of the top layer 30 can have different values, depending on the application.

In FIG. 1b, a layer-structure 10 according to a preferred embodiment of the invention is shown. Statements according to FIG. 1a shall apply mutatis mutandis to FIG. 1b. Corresponding features are labelled with the same reference signs.

The layer-structure 10 comprises a base layer 20, a top layer 30, a first color section 40, a second color section 45 and a primer layer 50.

In this embodiment, a first color section 40 and a second color section 45 are provided on the top surface 21 of the base layer 20. Preferably, the first color section 40 and the second color section 45 have a different luminance contrast with respect to the base layer 20.

The primer layer 50 has a top surface 51 and a bottom surface 52. The primer layer 50 extends in parallel with the base layer 20 and the top layer 30 substantially in the width direction WD and in the length direction LD. The bottom surface 52 of the primer layer 50 is in contact with the top surface 21 of the base layer 20, wherein the top surface 51 of the primer layer 50 is in contact with the bottom surface 32 of the top layer 30. The first 40 and the second color section 45 are completely covered by the primer layer 50.

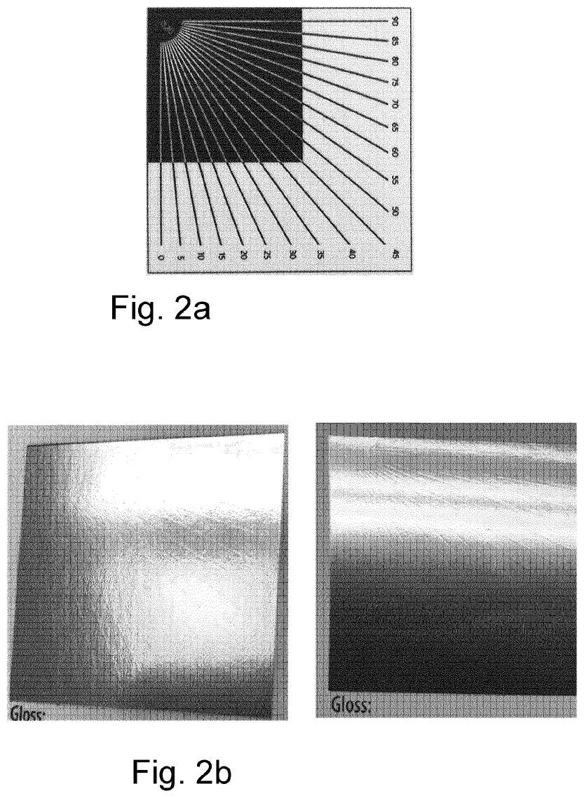

FIG. 2a shows a base layer 20 with a first color section 40. It is conceivable that the white part corresponds to the base layer 20 and the black part corresponds to the first color section 40 or that the white part corresponds to the top layer 30 and the black part corresponds to the base layer 30.

In FIG. 2b, the base layer 20 with the provided first color section 40 of FIG. 2a is shown from two different angles to enhance visibility of the claimed effect, covered by a top layer 30 in the form of a high-gloss silver ink composition. The luminance contrast of the top surface 21 of the base layer 20 and the first color section 40 is visible and a watermark visual appearance and/or embossing/debossing visual appearance is provided thereby as can be seen in FIG. 2b.

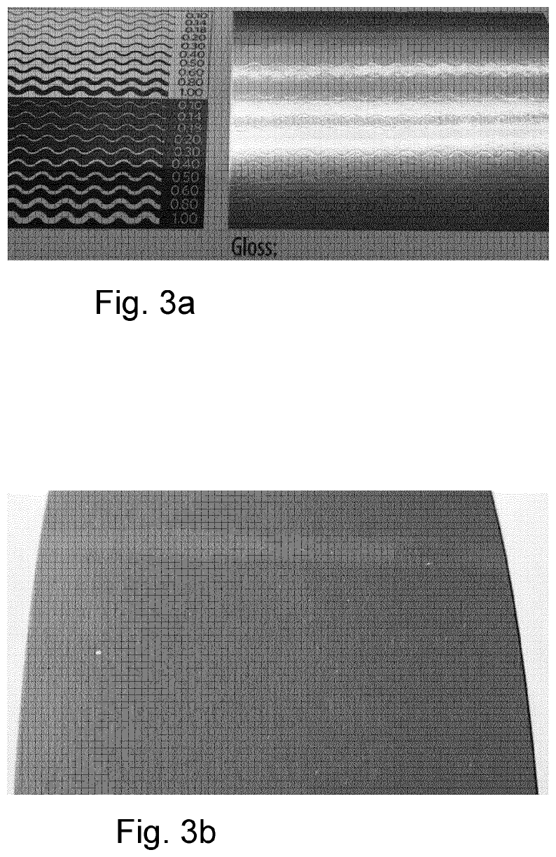

FIG. 3a shows a base layer 20 with a first color section 40 on the left. It is conceivable that the white part can correspond to the base layer 20 and the black part can correspond to the first color section 40 or that the white part can correspond to the top layer 30 and the black part can correspond to the base layer 30.

In FIG. 3a a base layer 20 with a first color section 40 is shown on the left, wherein said base layer 20 with the first color section 40 is covered by a top layer 30 in the form of a high-gloss silver ink composition on the righthand side, wherein the high-gloss silver ink composition has been applied by a printing method. The luminance contrast of the top surface 21 of the base layer 20 and the first color section 40 is visible and a watermark visual appearance and/or embossing/debossing visual appearance is observable.

FIG. 3b shows a base layer 20 with a first color section 40 covered by a top layer in the in the form of a high-gloss silver ink composition on the righthand side, wherein the high-gloss silver ink composition has been applied by a printing method. The luminance contrast of the top surface 21 of the base layer 20 and the first color section 40 is discernible providing a water-mark visual appearance and/or embossing/debossing visual appearance in the form of letters.

The size ratios of the different elements of the layer-structure as shown in FIGS. 1a, 1b, 2a, 2b, 3a. 3b are only schematically depicted and do not have to correspond to real ratios.

In table 1, exemplary embodiments of a base layer provided with different first color sections as well as the corresponding luminance contrasts are shown. The base layer in all the examples shown is the same, having a white color with a measured luminance Lₘₐₓ of 95.78 (reference Lₘₐₓ). For the first color section, different PMS colors (for Pantone® Matching System colors), as given in table 1, are used and the luminance L of each of the colors has been measured (corresponding to Lₘᵢₙ).

Furthermore, the calculated values for the Weber contrast C_{W} and the contrast Cₛᵢₘₚₗₑ are given in table 1. The Weber contrast C_{W} and the contrast Cₛᵢₘₚₗₑ have been calculated according to the equations cited above, using the measured luminances Lₘₐₓ and Lₘᵢₙ. The measuring parameters for the luminance values have been CIE-Lab (DIN EN ISO 11664-4), standard illuminant D50, density-standard DIN, no Pol-Filter and an angle of observation of 2°.

TABLE 1

| | | | Weber | |
|---|---|---|---|---|
| Samples | | luminance L | contrast C_{W} | Contrast Cₛᵢₘₚₗₑ |
| No. | Base layer | 95.78 | Reference Lₘₐₓ | Reference Lₘₐₓ |
| 1 | 440c | 22.11 | 3.33 | 4.33 |
| 2 | 2767c | 18.41 | 4.20 | 5.20 |
| 3 | Black C | 10.75 | 7.91 | 8.91 |
| 4 | 206c | 43.55 | 1.20 | 2.20 |
| 5 | 542c | 69.96 | 0.37 | 1.37 |
| 6 | 376c | 69.33 | 0.38 | 1.38 |
| 7 | Yellow C | 89.21 | 0.07 | 1.07 |

It was recognized that the described watermark visual appearance and/or embossing/debossing visual appearance was visible in samples 1 to 6. For sample 7, no watermark visual appearance and/or embossing/debossing visual appearance was discernible, since the value for the luminance contrast of the base layer (white) and the first color section (yellow) is too low.

The applicant reserves his right to claim all features disclosed in the application document as being an essential feature of the invention, as long as they are new, individually or in combination, in view of the prior art. Furthermore, it is noted that in the figures, features are described, which can be advantageous individually. Someone skilled in the art will directly recognize that a specific feature being disclosed in a figure can be advantageous, also without the adoption of further features from this figure. Furthermore, someone skilled in the art will recognize that advantages can evolve from a combination of diverse features being disclosed in one or various figures.

### LIST OF REFERENCE SYMBOLS

10 layer-structure
20 base layer
21 top surface of the base layer
30 top layer
31 top surface of the top layer
32 bottom surface of the top layer
40 first color section
45 second color section
50 primer layer
51 top surface of the primer layer
52 bottom surface of the primer layer
D thickness of the top layer
HD height direcion
LD length direction
WD width direction

1. A layer-structure, comprising at least a base layer with a top surface and a top layer, wherein the top layer is arranged above the base layer in a height direction,
wherein a first color section is partially provided in and/or on the top surface of the base layer, the first color section and the top surface of the base layer having a luminance contrast, wherein the luminance contrast, defined as Weber contrast, has a value that is at least 0.20, and wherein the first color section and the top surface of the base layer are covered by the top layer, so that a watermark visual appearance is provided.

2. The layer-structure according to claim 1, wherein:
the value of the luminance contrast, defined as Weber contrast, is at least 0.25.

3. The layer-structure according to claim 1, wherein:
the top layer consists of a metallic gloss ink composition comprising metallic particles.

4. The layer-structure according to claim 3, wherein:
the metallic gloss ink composition is printed on the top surface of the base layer and the first color section.

5. The layer-structure according to claim 1, wherein:
the first color section is provided as line textures and/or solid design elements.

6. The layer-structure according to claim 1, wherein:
the first color section consists of an ink composition, said ink composition being printed on the top surface of the base layer.

7. The layer-structure according to claim 1, wherein:
the first color section has a color with a tone value range between 50% and 100%.

8. The layer-structure according to claim 1, wherein:
a bottom surface of the top layer is in contact with the first color section and the top surface of the base layer.

9. The layer-structure according to claim 1, wherein:
a primer layer is arranged between the base layer and the top layer in the height direction of the layer-structure.

10. The layer-structure according to claim 9, wherein:
the primer layer is in contact with the top surface of the base layer, the first color section and a bottom surface of the top layer, covering the top surface of the base layer and the first color section.

11. The layer-structure according to claim 1, wherein:
the top layer is continuous and/or has a uniform thickness throughout.

12. The layer-structure according to claim 1, wherein:
at least a second color section is provided in and/or on the top surface of the base layer.

13. The layer-structure according to claim 12, wherein:
the first color section consists of an ink composition, said ink composition being printed on the top surface of the base layer, and the at least second color section consists of the same ink composition as the first color section.

14. A method of producing a layer-structure, comprising the steps:
a) providing a base layer with a top surface;
b) providing a first color section in and/or on parts of the top surface of the base layer;
c) providing a top layer above the base layer in a height direction of the layer-structure, covering the first color section and the top surface of the base layer;
wherein the first color section and the top surface of the base layer have a luminance contrast, wherein the luminance contrast, defined as Weber contrast, has a value that is at least 0.20.

15. The method according to claim 14, comprising the additional step:
d) providing a primer layer between the base layer and the top layer;
wherein the step d) is conducted after the step b).

16. A packaging material comprising the layer-structure according to claim 1.

17. A packaging comprising a folded blank of the packaging material according to claim 16.

18. The layer-structure according to claim 12, wherein:
the first color section consists of an ink composition, said ink composition being printed on the top surface of the base layer, and the at least second color section consists of a different ink composition than the first color section, having a different color and/or different components.
